(19) United States
(12) Patent Application Publication
(10) Pub. No.: US 2013/0002395 A1
(43) Pub. Date: Jan. 3, 2013

(54) PTC Resistor

(75) Inventors: Frederic Luizi, Malonne (BE); Luca Mezzo, Nole (IT); Jean-François Feller, Queven (FR); Mickaël Castro, Lorient (FR)

(73) Assignees: UNIVERSITE DE BRETAGNE SUD, Lorient (FR); NANOCYL S.A., Sambreville (BE)

(21) Appl. No.: 13/514,492

(22) PCT Filed: Oct. 26, 2010
(86) PCT No.: PCT/EP10/66164

§ 371 Date: Sep. 11, 2012

(30) Foreign Application Priority Data
Dec. 8, 2009 (EP) 09178371.2

(51) Int. Cl. H01C 7/02

(52) U.S. Cl. 338/25

(57) ABSTRACT

The present invention is related to a polymer fibre-based PTC resistor comprising a co-continuous polymer phase blend, said blend comprising a first and a second continuous polymer phase, wherein the first polymer phase comprises a dispersion of carbon nanotubes at a concentration above the percolation threshold, said first polymer phase presenting a softening temperature lower than the softening temperature of the second polymer phase.

### FIELD OF THE INVENTION

The invention is related to a polymer fibre-based PTC resistor.

### BACKGROUND

Positive Temperature Coefficient (PTC) resistors (thermistors) are thermally sensitive resistors which show a sharp increase in resistance at a specific temperature. Said specific temperature is usually called the PTC transition temperature or switching temperature.

Change in the resistance of a PTC resistor can be brought about either by a change in the ambient temperature or internally by self-heating resulting from current flowing through the device. PTC materials are sometimes used to make heating elements. Such elements act as their own thermostats, switching off the current when reaching their maximum temperature.

Commonly used PTC materials include high density polyethylene (HDPE) filled with a carefully controlled amount of graphite, so that the volume increase at the melting temperature causes the conducting particles to break contact and to interrupt the current.

Such devices usually need to be encapsulated in a high melting temperature material in order to maintain their integrity at temperatures above the melting temperature of HDPE (125° C.).

A limitation of the PTC based on HDPE is that the switching temperatures is limited to the range of melting temperature available for that material.

Another strategy to improve the heat stability of such devices consists in the cross-linking of the polymer composition. Such a strategy is for example disclosed in the document WO01/64785. Such a cross linking can be obtained either by adding a chemical cross-linker to the polymer composition or by physical methods such as irradiation. Such a cross-linking is usually difficult to implement in industrial processes due to the high costs of the irradiation installation or to the difficulty to control the chemical cross-linking (too early cross-linking in the process or insufficient bridging).

Furthermore, the usual shape of such PTC devices is a plane polymeric composition encapsulated between two conductive electrodes. Such geometry prevents the inclusion of such devices in a textile or a fabric.

### AIMS OF THE INVENTION

The present invention aims to provide a polymer fibre-based PTC resistor that overcomes the drawbacks of the prior art.

More particularly, the present invention aims to provide a compact and self supported polymer fibre-based PTC resistor.

The present invention also aims to provide a PTC resistor suitable for use in a textile or a fabric.

### SUMMARY OF THE INVENTION

The present invention is related to a polymer fibre-based PTC resistor comprising a co-continuous polymer phase blend, said blend comprising a first and a second continuous polymer phase, wherein the first polymer phase comprises a dispersion of carbon nanotubes at a concentration above the percolation threshold, said first polymer phase presenting a softening temperature lower than the softening temperature of the second polymer phase.

According to particular preferred embodiments, the invention further discloses at least one or a suitable combination of the following features:
said first polymer is selected from the group consisting of polycaprolactone, polyethylene oxide and biopolyester;
said second polymer phase is selected from the group consisting of polyethylene, polypropylene, polylactic acid and polyamide;
the first polymer phase represents more than 40% by weight of the fibre;
the carbon nanotubes are multiwall carbon nanotubes, having preferably a diameter comprised between 5 and 20 nm;
the PTC transition temperature is comprised between 30 and 60° C.;
the first and second polymer phase are biodegradable polymers according to ASTM 13432 or ASTM 52001.

Another aspect of the invention is related to a fabric comprising a PTC resistor according to the invention.

### BRIEF DESCRIPTION OF THE DRAWINGS

FIG. 1 represents the spinning process for the production of the fibres of the present invention.

FIG. 2 represents a SEM analysis of a transverse section of a PP/PCL blend 50/50 with 3% CNT dispersed in the PCL phase.

FIG. 3 represents a graph of the continuity ratio of PCL+CNT in a PP or PA matrix measured by selective extraction of PCL+CNT using acetic acid.

FIG. 4 represents the electrical conductivity as a function of the weight fraction of PCL in both PA12 and PP.

FIG. 5 represents SEM pictures of PA12/PCL blends at 50/50 wt, with 3% CNT in the PCL phase, after extraction of the PCL phase.

FIG. 6 represents the variation of the resistance as a function of the temperature of two fibres of sample 9: Biopolyester (BPR)/PP.

FIG. 7 represents the variation of the resistance as a function of the temperature of two fibres of sample 10 BPR/PE.

FIG. 8 represents the variation of the resistance as a function of the temperature of the fibres of samples 3 and 4 (PCL/PP).

FIG. 9 represents the variation of the resistance as a function of the temperature of the fibres of samples 7, 8 and 9 (BPR/PLA).

FIG. 10 represents the variation of the resistance as a function of the temperature of the fibres of samples 10 (PEO/PP).

FIG. 11 represents the variation of the resistance as a function of temperature of the fibres of sample 11 (PEO/PA12).

### DETAILED DESCRIPTION OF THE INVENTION

The present invention is related to a polymer fibre-based PTC resistor. The polymer fibre based PTC resistor comprises a blend of at least two co-continuous polymer phases. By co-continuous phase blend, it is meant a phase blend comprising two continuous phases.

The first polymer phase comprises a conductive filler, such as carbon nanotubes. Said first polymer phase has a softening temperature close to the targeted PTC transition temperature. The concentration of the conductive filler below the PTC transition temperature in the first phase is above the percolation threshold, so that the first polymer phase is conductive.

The expression “softening temperature” has to be understood as the temperature at which the polymer phase becomes liquid. This transition corresponds either to the glass transition temperature for glassy materials or to the melting temperature for semi-crystalline materials.

The percolation threshold is the minimum filler concentration at which a continuous electrically conducting path is formed in the composite. Said threshold is characterised by a sharp increase of the conductivity of the blend with an increasing filler concentration. Usually, in conductive polymer composites, this threshold is considered to be the concentration of the filler which induces a resistivity of less than 10⁶ ohm·cm.

At temperatures higher than the PTC transition temperature, the first polymer phase is above its softening temperature, and hence, the mechanical properties of the first polymer phase severely drop. For that reason, a supporting material is necessary to maintain the mechanical integrity of the fibre. This supporting material is formed by the second polymer phase. The second polymer phase is selected to maintain the physical integrity of the fibre at the maximum temperature of use, above the PTC transition temperature. Therefore, the softening temperature of the second polymer phase is always chosen so as to be higher than the softening temperature of the first polymer phase.

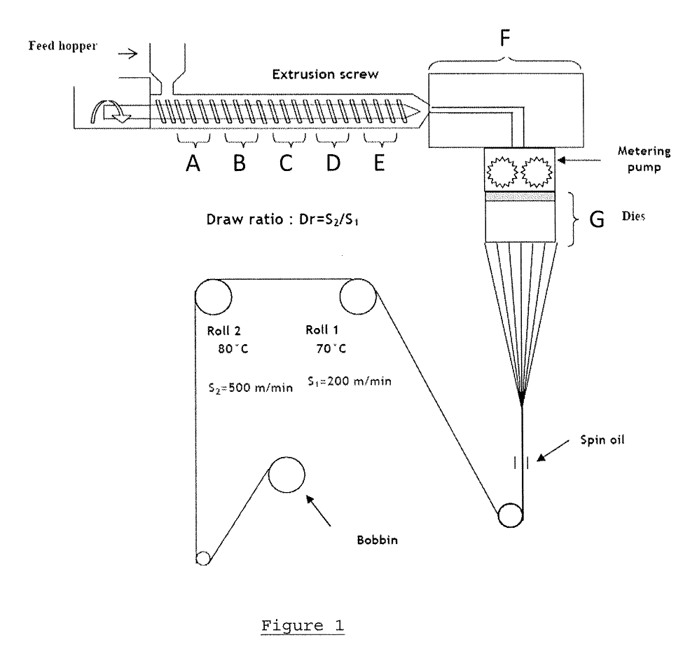

The fibres are produced in a spinning process, as shown in FIG. 1. The use of fibres brings several advantages: the surface to volume ratio can be optimized by using several fibres in bundles, optimising the thermal exchange surfaces, the fibres can be included in smart textile, they can easily be shaped in various geometrical forms, etc.

The compatibility of the polymer blend has an impact on the spinnability of the biphasic systems. More particularly, the adhesion between both phases improves the spinnability of the blend. The adhesion can be achieved either by the selection of intrinsically adhering pairs of polymers or by the addition of a compatibilizer in one of the polymer phases. Examples of compatibilizers are maleic anhydride grafted polyolefins, ionomers, bloc copolymers comprising a bloc of each phase, etc. The cohesion has also an impact on the blend morphology.

To enable the co-continuity of phases, the ratio of viscosities between the two phases of the biphasic system should preferably be close to 1. The other parameters determining the co-continuity are the nature of the polymers (viscosities, interfacial tension and the ratio of these viscosities), their volume fractions and the processing conditions.

Biopolymers are polymers produced by living organisms or originating from living resources. Some biopolymers are biodegradable. An example of a biodegradable polyester is polylactic acid (PLA). Within biopolymers, biopolyesters may be produced by a wide variety of bacteria as intracellular reserve materials. Those biopolyesters are receiving increased attention for possible applications as biodegradable, melt processable polymers which can be produced from renewable resources. The within biopolyesters, linear polyhydroxyalkanoate represents the most commonly used polymer family. The poly-3-hydroxybutyrate (P3HB) form of PHB is probably the most common type of polyhydroxyalkanoate, but many other polymers of this class are produced by a variety of organisms: these include poly-4-hydroxybutyrate (P4HB), polyhydroxyvalerate (PHV), polyhydroxyhexanoate (PHH), polyhydroxyoctanoate (PHO) and their copolymers.

The members of this family of thermoplastic biopolymers can show variation in their material properties from rigid brittle plastics, to flexible plastics with good impact properties to strong tough elastomers, depending on the size of the pendant alkyl group, R, and the composition of the polymer. This variability in the material properties permits to select precisely the transition temperature for a given application, from low melting temperature aliphatic polyesters, such as described hereafter to high melting temperature polyesters.

### EXAMPLES

The examples presented are related to blends comprising:
Poly(ε-caprolactone) (PCL), polyethylene oxide (PEO), and BPR as the first polymer phase;
polypropylene (PP), polyethylene (PE), polylactic acid (PLA) and polyamide 12 (PA12) as the second polymer phase;
Carbon Nanotubes (CNT).

PCL, namely CAPA 6800 from Solvay, is a biodegradable polymer with a relatively low melting temperature of about 60° C. The polyethylene oxide was provided by Sima Aldrich, the grade name was PEO 181986, having a melting temperature of 65° C. BPR is a biopolyester synthesised from vegetable oil, as described by F. Laflêche et Al. in “Novel aliphatic polyesters based on oleic diacid D18:1, synthesis, epoxidation, cross-linking and biodegradation”, submitted to JAOC (2009). This polymer has a melting temperature of about 35° C.

PP of the type H777˜25R from DOW was chosen (Tm˜165-170° C.). PE is a low density poly(ethylene) LDPE Lacqtene® 1200 MN from Arkema (Tm˜110° C.). PLA is a poly(L-lactic acid) L9000 from Biomer (Tm˜178° C.). PA12 was Grilamid L16E from EMS-Chemie. These PP, PE, PLA and PA12 are spinning types and should lead to a good spinnability of the blends.

Composites of these polymers with various weight contents of carbon nanotubes (CNT) from Nanocyl were prepared with various weight fractions. Carbon nanotubes are multi wall carbon nanotubes with a diameter between 5 and 20 nm preferably between 6 and 15 nm and with a specific surface area between 100 m²/g and 600 m²/g preferably between 100 m²/g and 400 m²/g.

The production of the fibres was carried out in a two step process. In a first step, the carbon nanotubes were dispersed in the first polymer in a twin-screw compounding extruder. The obtained extrudates were then pelletized and dry blended with the second polymer.

The obtained dry blend was then fed in the hopper of a single-screw extruder, feeding a spinning die as represented in FIG. 1. The temperatures in the various zones corresponding to FIG. 1 are summarised in table 1. The temperatures were fixed for a given second polymer phase.

TABLE 1
Temperatures in ° C. in the various
extrusion zones corresponding to FIG. 1

| First polymer | A | B | C | D | E | F | G |
|---|---|---|---|---|---|---|---|
| PP | 180 | 190 | 200 | 210 | 230 | 230 | 230 |
| PE | 160 | 180 | 190 | 200 | 210 | 210 | 210 |
| PLA | 160 | 180 | 190 | 200 | 210 | 210 | 210 |
| PA12 | 180 | 185 | 190 | 195 | 200 | 200 | 200 |

The composition of the PTC prepared for further experiments are detailed in Table 2.

TABLE 2
PTC compositions used in co-continuity and conductivity experiments.

| | | | CNT weight |
|---|---|---|---|
| | | First polymer | fractions |
| | polymer | phase weight | in the first |
| | blend | fraction | polymer phase |
| Sample 1 | PCL/PP | 20/80 | 3 |
| Sample 2 | PCL/PP | 30/70 | 3 |
| Sample 3 | PCL/PP | 40/60 | 3 |
| Sample 4 | PCL/PP | 50/50 | 3 |
| Sample 5 | BPR/PP | 50/50 | 2 |
| Sample 6 | BPR/PE | 50/50 | 2 |
| Sample 7 | BPR/PLA | 50/50 | 3 |
| Sample 8 | BPR/PLA | 50/50 | 4 |
| Sample 9 | BPR/PLA | 40/60 | 4 |
| Sample 10 | PEO/PP | 50/50 | 3 |
| Sample 11 | PEO/PA12 | 50/50 | 3 |

A melt spinning machine (Spinboy I manufactured by Busschaert Engineering) was used to obtain the multifilament yarns. The multifilament yarns are covered with a spin finish, rolled up on two heated rolls with varying speeds (S1 and S2) to regulate the drawing ratio. The theoretical drawing of multifilament yarns is given by the ratio DR═S2/S1. During the fibre spinning, the molten polymer containing nanotubes is forced through a die head of a diameter of 400 μm or 1.2 mm depending on the polymer and through a series of filters. Several parameters were optimized during the process to obtain spinnable blends. These parameters were mainly the temperature of the heating zones, the volume pump speed and the roll speed.

### Determination of the PCL Phase Continuity by Selective Extraction

An extended study of the co-continuity of the PP/PCL and PA12/PCL blends have been performed. The selective extraction of one phase provides a good estimation of the co-continuity of a mixture. This was achieved by the dissolution of PCL into acetic acid, this solvent having no effect on PA12 and PP. If the mixture has a nodular structure, the PCL inclusions will not be affected by the solvent and will not be dissolved. The percentage of the PCL phase continuity is then deduced by weight loss measurements.

To remove the soluble PCL polymer phase, fibres of each blend were immersed in acetic acid for 2 days at room temperature. The extracted strands were then rinsed in acetic acid and dried at 50° C. to remove the acetic acid. After repeating the extraction process several times, the specimen weight converged toward a constant value.

The phase continuity was calculated using the ratio of the soluble PCL polymer part to the initial PCL concentration in the blend, where the dissolvable PCL part is the weight difference of the sample before and after extraction.

The PCL part in the blend is calculated using the following equation:

% Continuity of the PCL=((Weight PCL initial−Weight PCL final)/Weight PCL initial)*100%

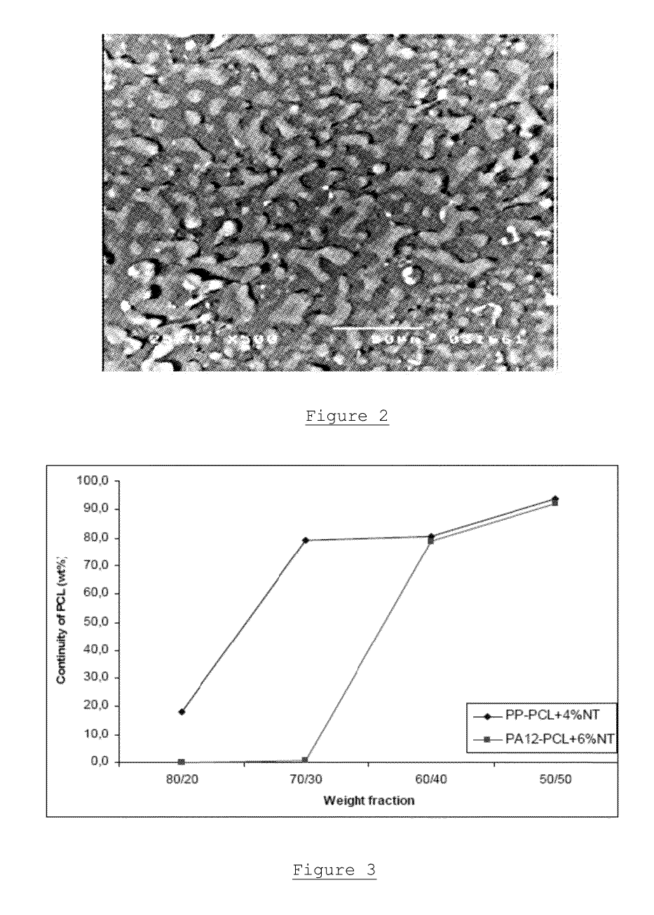

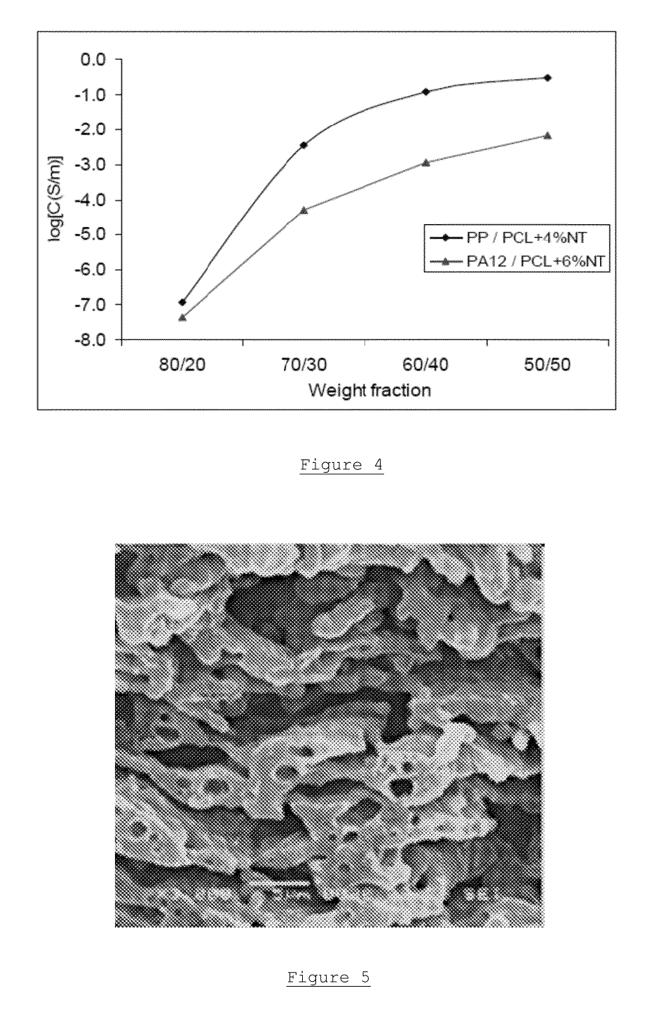

The results are represented in FIG. 3. This figure shows that the continuity of the PCL is reached around 40% PCL in PA12 and 30% PCL in PP.

### PTC Measurement.

Electrical resistance measurements were performed with a Keithley multimeter 2000 at varying temperatures. The resistance of the fibre was measured every 10 s. The relative amplitude was then defined as (R−R0)/R0, where R0 is the initial resistance of the composite (i.e. resistance at 20° C.)

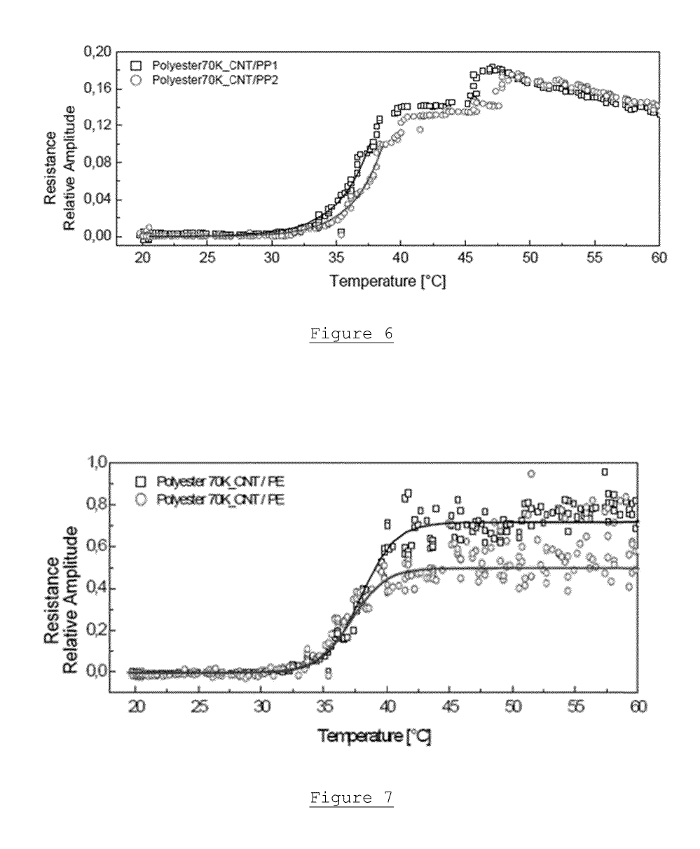

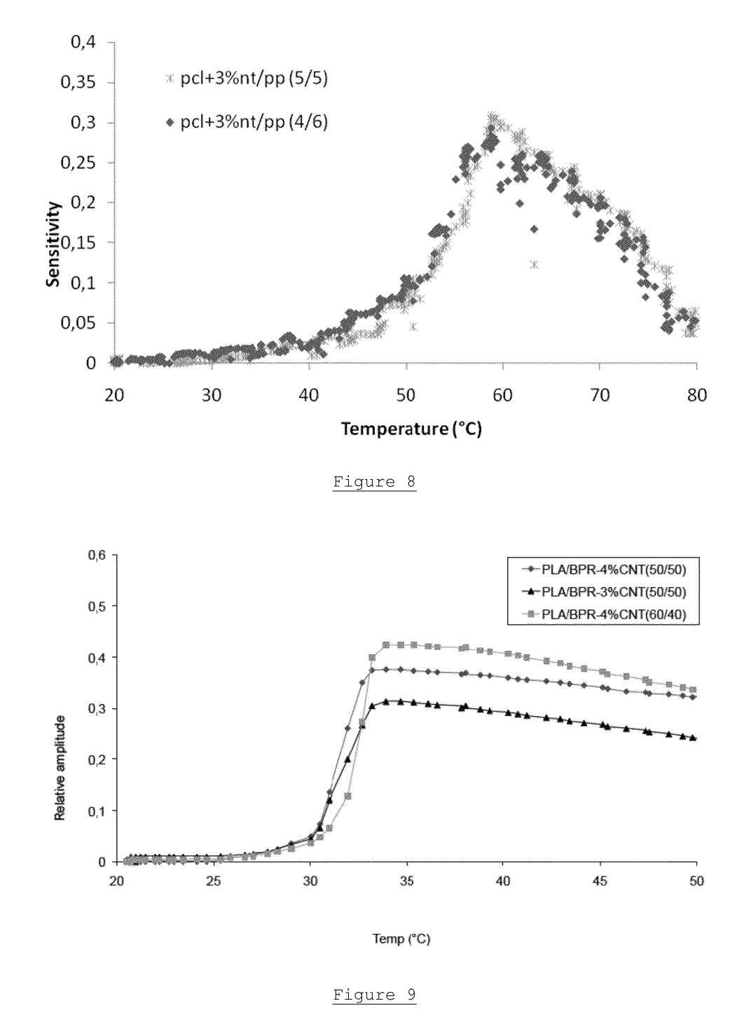

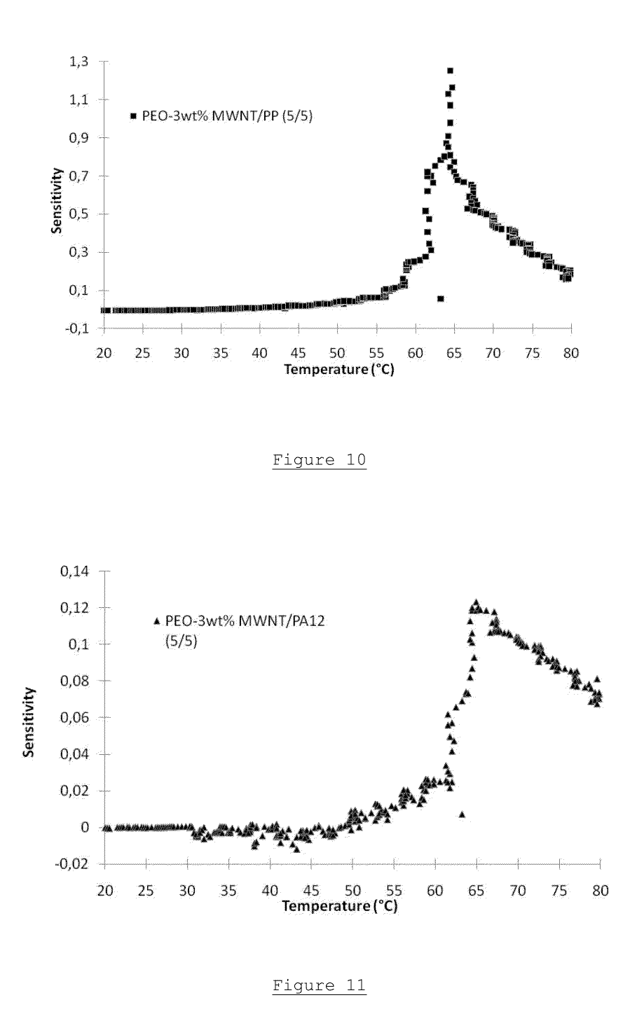

The relative amplitudes obtained with the different samples are represented in FIGS. 6 to 11.

1. Polymer fibre-based PTC resistor comprising polymer fibres, said polymer fibres comprising a co-continuous polymer phase blend, said blend comprising a first and a second continuous polymer phase, wherein the first polymer phase comprises a dispersion of carbon nanotubes at a concentration above the percolation threshold, said first polymer phase presenting a softening temperature lower than the softening temperature of the second polymer phase.

2. Polymer fibre-based PTC resistor according to claim 1, wherein said first polymer is selected from the group consisting of polycaprolactone, polyethylene oxide and biopolyester.

3. Polymer fibre-based PTC resistor according to any of the previous claims, wherein said second polymer phase is selected from the group consisting of polyethylene, polypropylene, polylactic acid and polyamide.

4. Polymer fibre-based PTC resistor according to any of the previous claims, wherein the first polymer phase represents more than 40% by weight of the fibre.

5. Polymer fibre-based PTC resistor according to any of the previous claims, wherein the carbon nanotubes are multiwall carbon nanotubes.

6. Polymer fibre-based PTC resistor according to claim 5, wherein said multiwall carbon nanotubes have a diameter comprised between 5 and 20 nm.

7. Polymer fibre-based PTC resistor according to any of the previous claims, wherein the PTC transition temperature is comprised between 30 and 60° C.

8. Polymer fibre-based PTC resistor according to any of the previous claims, wherein the first and second polymer phase are biodegradable polymers according to ASTM 13432 or ASTM 52001.

9. A fabric comprising a polymer fibre-based PTC resistor according to any of the claims 1 to 8.
